(19) United States
(12) Patent Application Publication
(10) Pub. No.: US 2007/0184678 A1
(43) Pub. Date: Aug. 9, 2007

(54) Connector

(76) Inventors: Nik Codling, Whiteley (GB); Peter Collins, Whiteley (GB)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/649,472

(22) Filed: Jan. 4, 2007

(30) Foreign Application Priority Data
Jan. 6, 2006 (GB) 0600234.9

(51) Int. Cl. H01R 12/00

(52) U.S. Cl. 439/66

(57) ABSTRACT

A Connector comprising a rigid base member covered by a resilient layer base member further comprising a contact member formed of a head portion and a stem portion, whereby the head portion is arranged to project from the outer surface of the resilient layer and the stem portion is located within the base member and the resilient layer, the stem portion being held in position by a retaining member. Preferably, the resilient layer is formed of an elsatomer material which extends around the periphery of the connector.

The present invention relates to connectors. In particular the present invention relates to a re-usable connector suited for use in outdoor environments and suitable for exposure to temperature variations.

Connectors can be in a variety of shapes and sizes, and can be used to connect certain pieces of equipment together, when the connector is attached to each piece of equipment.

The present invention provides a connector device comprising a housing with a contact arranged to communicate with another contact from a similar corresponding connector device, wherein the housing is formed from an elastomer material.

In order that the present invention can be more readily understood, an embodiment thereof will be described by way of example with reference to the accompanying drawings in which;

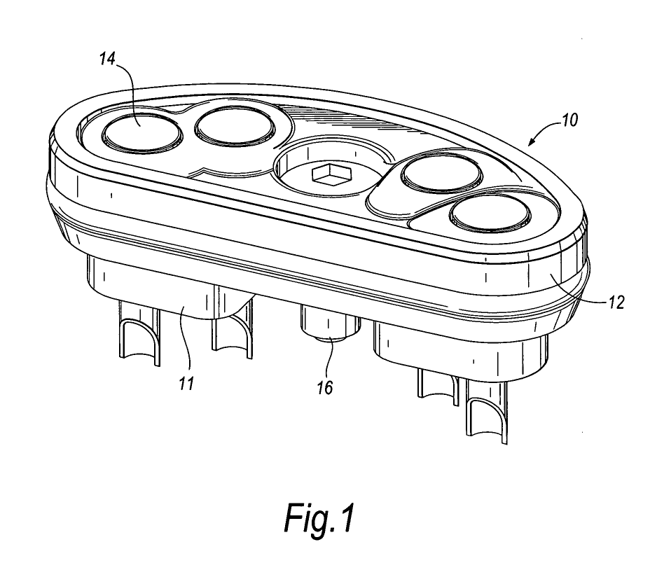

FIG. 1 shows a perspective view of a connector according to a preferred embodiment;

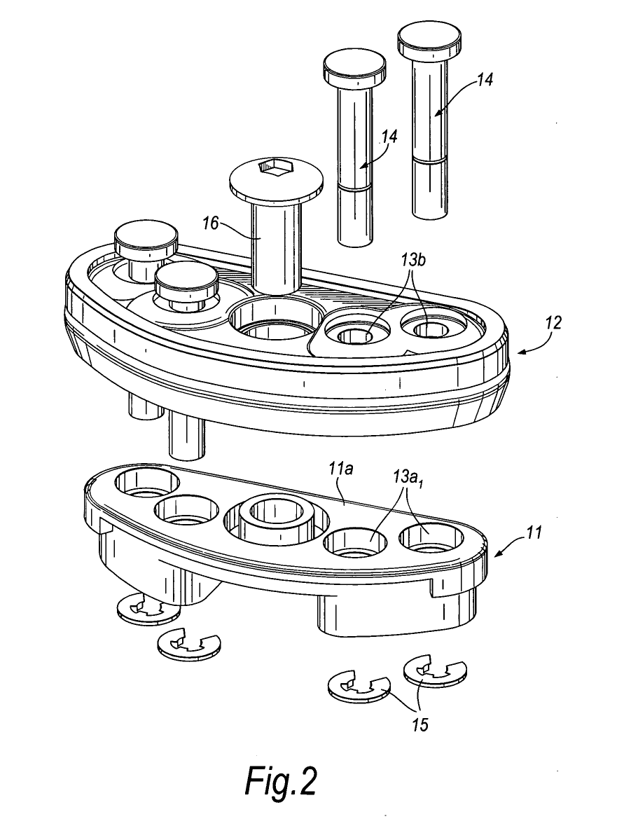

FIG. 2 shows an exploded perspective view of the connector of FIG. 1;

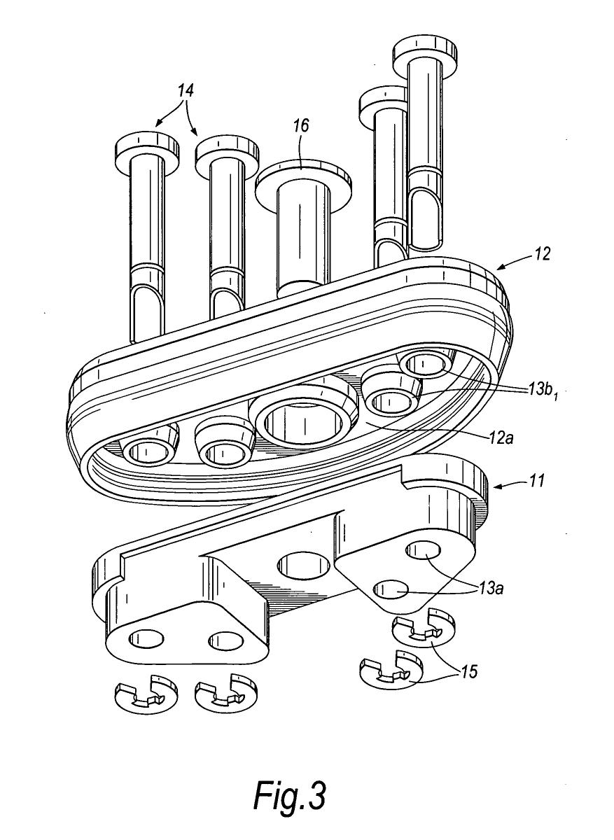

FIG. 3 shows an exploded perspective view from the underside of the connector in FIG. 1;

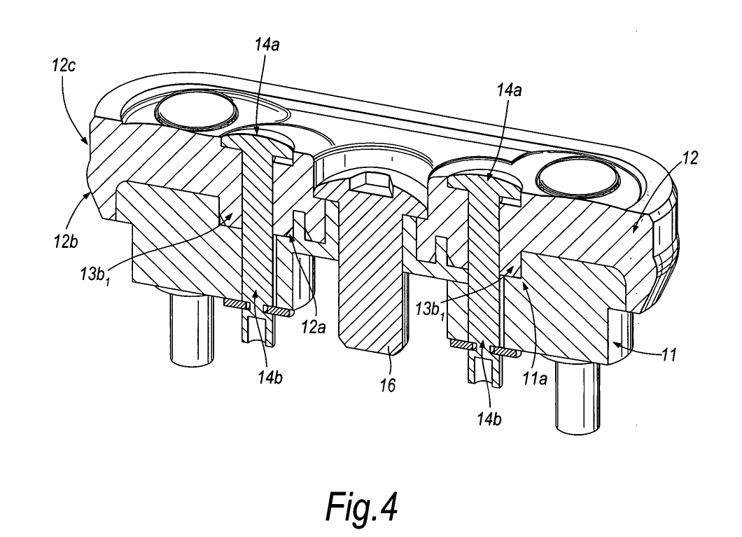

FIG. 4 shows a sectional view taken along a major axis of the connector in FIG. 1.

The type of connectors utilised in the present invention are suited for a variety of applications and one such connectors is used with a corresponding identical connector in order to form a secure connection. That is, the connectors are not of the male and female type which is the case with many conventional connectors but connectors of identical configuration may be utilised in order to form the connection.

A preferred embodiment of the present invention will be described with reference to FIGS. 1 to 4 and it will be appreciated that the present invention is not limited to the particular design illustrated. Furthermore, the description will be referred to in respect of a single connector but it will be appreciated that two such connectors will be used to form a connection.

As shown in FIG. 1 to FIG. 3, a connector 10 comprises a base moulding 11 formed of a hard wearing grade of material which may be for example polyester or polyamide mould material. The connector 10 further comprises a separate component 12 of a similar shape to the base moulding 11 and is attached to the base moulding 11.

The component 12 is formed by a silicone based elastomer material and is arranged to cover the otherwise exposed top surface 11a of the base moulding 11 but be capable of being used with other designs of base moulding 11.

A plurality of contact recesses 13a are arranged in the base moulding 11 and corresponding recesses 13b are provided in the component 12. In this particular embodiment, four contact recesses are provided in the connector 10 but a different number may be provided depending on the particular design required.

Contacts 14 are loaded through the component 12 into the base moulding 11 and pretensioned by means of compressing the component 12 under the head of the contact 14. Head 14a of the contact 14 is arranged to project from the outer surface of the component 12 and stem 14b of the contact 14 passes through the component 12 and the base moulding 11. This serves two purposes; firstly, it provides a minimum contact spring force and secondly it compresses the contact 14 into the component 12 to effectively seal it from water ingress. The contact 14 is subsequently retained in its pretensioned position by a circlip 15. Any other suitable form of retainer may be utilised to hold the contact in position.

During the mating cycle, the contact 14 is compressed from the front face of the connector 10, sliding through the base moulding 11, acting against the reactive force applied by the component 12 in reaction to its compression. The contacts are a sliding fit in the base moulding 11. As shown in FIG. 4, during this compression, the component 12 is also forced further into a seal recess 11a in the base moulding 11 identified above, increasing the force applied to the circumference of the contact body shaft and increasing the ability to keep moisture ingress prevented.

The elastomer component 12 is designed in such a way as to allow compression into the seal recess 11a a without creating excess force by means of including an expansion space 12a (explained in more detail below) in the elastomer component 12 to allow for expansion by the component 12. The difference in profile of the elastomer component 12 and the base moulding 11 allow movement and compression whilst controlling the reactive force applied on the contact 14 by the elastomer components compression.

With reference to FIG. 3 which shows the underside of the elastomer component 12 and base moulding 11 in more detail, the recesses 13b are of similar diameter as the corresponding recesses 13a in the base moulding 11. Accordingly, the contacts 14 can be held securely in the recesses and provide a connection between the base moulding 11 and the elastomer component 12. To allow the contacts 14 to provide a sealing force when depressed, a plurality of extensions 13b₁ extended transverse to the planar surface 12a of the underside of the component 12 and surround the respective recesses 13b. The ends of each extension 13b₁ are slightly tapered inwards. That is the cross section of the extension 13₁, is not constant along its length but is reduced near its end portion. A plurality of corresponding wells 13a, are provided in the base moulding 11 but unlike the extensions 13b₁ the wells 13a, are of a constant cross-sectional shape. Accordingly, when the connector is assembled, as shown in FIG. 4, the extension space 12a exists allowing for expansion of the extension 13b₁ across the wells 13a, in the base moulding 11 when the contacts 14 are depressed. Furthermore the extensions 13b, allow for easy alignment and assembly of the elastomer component 12 and the base moulding 11.

When installed into a particular application housing (not shown), the entire connector 10 is sealed in the following manner.

When tightened, a retaining bolt 16 compresses the base of the counterbore within the front face of the elastomer component 12 to prevent moisture ingress past the bolt 16. The purpose of the bolt 16 is to retain the connector 10 within its intended housing (not shown). In addition, the central position of the bolt 16 in the preferred embodiment is such that the sealing function is maintained across the connector. However, it will be appreciated that more than one bolt may be utilised in the connector.

The external profile of the elastomer component 12 is designed in such a way as to have a lead in section 12b to allow ease of assembly prior to the elastomer component 12 being compressed and a seal formed. This is achieved by a tapered profile, the narrowest section being a set dimension smaller that the opening to which it fits. This taper increases in a linear manner until a seal bead area 12c is reached, giving maximum compression between the connector and the housing and creating the seal.

When two identical parts are mated, the elastomer profile around the perimeter of the connector 10 and around each contact 14 meet and compress to seal from moisture ingress. Each contact 14 mates just prior to the elastomer seals meeting to ensure adequate contact force is applied. Therefore, it is apparent that the connection between the two parts is made when the faces of the contacts meet, and the seal is generated by compressing the elastomer.

The seal profiles around each contact 14 have been designed in such a way as to self drain should moisture collect on the mating surface by means of a section of a hemispherical profile. This profile channels any standing moisture away from each mating face. When fully mated, each seal section squeezes out any moisture preventing tracking across the surface of the connector 10.

Accordingly it is apparent that the use of the elastomer in the following manner provides the advantages of the present invention:
Combined use of elastomeric material for both contact spring force and sealing of contacts within the contacts.
Combined use of the elastomer for contact forces and seals and to seal the assembly in the housing

It will be appreciated that, although not shown, the connector may be provided with mechanical linkages depending on the type of application to which the connector is required, in order to connect two identical connectors together to form a connection.

Moreover, the shape of the connector could vary but it is the presence of the elastomer component that enables the connector to exhibit self sealing characteristics in that as each contact is depressed, the seal is effectively tightened due to material compression.

1. A connector comprising a rigid base member covered by a resilient layer base member further comprising a contact member formed of a head portion and a stem portion, whereby the head portion is arranged to project from the outer surface of the resilient layer and the stem portion is located within the base member and the resilient layer, the stem portion being held in position by a retaining member.

2. The connector of claim 1 wherein the resilient layer is formed of an elastomer material which extends around the periphery of the connector.

3. The connector of claim 2 wherein the base member comprises a plurality of shaped recesses, and the resilient layer comprises a plurality of shaped extensions arranged within the recesses, wherein the cross sectional shape of the recesses differs to that of the shaped extensions, such that a plurality of expansion spaces exist between the base member and the resilient layer.

4. The connector of claim 2, wherein the respective head portions of the connector are arranged so as to mate with a like connector.

5. The connector of claim 4 wherein the elastomer material of the connector forms a seal between the like connector when mated therewith.
